(19) United States
(12) Patent Application Publication
(10) Pub. No.: US 2020/0055997 A1
(43) Pub. Date: Feb. 20, 2020

(54) SEMI-CRYSTALLINE POLYOLEFIN-BASED ADDITIVE MASTERBATCH COMPOSITION

(71) Applicant: Dow Global Technologies LLC, Midland, MI (US)

(72) Inventors: Dachao Li, Royersford, PA (US); Timothy J. Person, Pottstown, PA (US); Jeffrey M. Cogen, Flemington, NJ (US); Manish K. Mundra, Collegeville, PA (US); Peter C. Dreux, Lumberton, NJ (US); Rajen M. Patel, Freeport, TX (US)

(21) Appl. No.: 16/343,901

(22) PCT Filed: Oct. 31, 2017
(86) PCT No.: PCT/US2017/059217

§ 371 Date: Apr. 22, 2019

Related U.S. Application Data
(60) Provisional application No. 62/576,194, filed on Oct. 24, 2017.
(60) Provisional application No. 62/416,407, filed on Nov. 2, 2016.
(60) Provisional application No. 62/416,415, filed on Nov. 2, 2016.

(51) Int. Cl. C08J 3/22; C08L 23/08; C08L 33/08; C08L 23/14; C08L 23/26; C08K 3/013; C08K 3/22; C08K 5/02

(52) U.S. Cl. CPC C08J 3/226; C08L 23/08; C08L 33/08; C08L 23/14; C08L 23/26; C08K 3/013; C08L 2207/062; C08K 5/02; C08L 2201/02; C08L 2310/00; C08K 2003/2296; C08L 2203/202; C08L 2203/30; C08K 3/2279

(57) ABSTRACT

An additive masterbatch composition comprising a semi-crystalline polyolefin carrier resin and an additive package comprising a flame retardant. A moisture-curable polyolefin composition comprising the additive masterbatch composition and a (hydrolyzable silyl group)-functional polyolefin prepolymer. A method of making the compositions; a moisture-cured polyolefin composition prepared therefrom; a manufactured article comprising or made from the formulation; and a method of using the manufactured article.

### FIELD

The field includes a semi-crystalline polyolefin-based additive masterbatch composition, moisture curable polyolefin compositions prepared therewith, methods of making and using same, and articles containing or made from same.

### INTRODUCTION

A masterbatch generally is a solid or liquid additive for imparting color (color masterbatch) or other properties (additive masterbatch) to a host material, typically a host polymer. The masterbatch contains a carrier resin and a pigment (color masterbatch) or one or more additives (additive masterbatch). To make a final product, a masterbatch is mixed or blended with a host material to give the final product. The concentration of colorant in the color masterbatch and the concentration(s) of the one or more additives in the additive masterbatch are typically much higher than target concentration(s) thereof in the final product. To make a polyolefin product, a solid masterbatch, usually in the form of granules or pellets, is mixed (e.g., blended) with a solid host polymer, usually in the form of granules or pellets, and the resulting mixture is melted or extruded to make a polyolefin product. Low density polyethylene (LDPE), ethylene/vinyl acetate (EVA) copolymer or ethylene/ethyl acrylate (EEA) copolymer is typically used as a carrier resin for solid masterbatches used to make polyolefin products.

U.S. Pat. No. 6,936,655 B2 to J. S. Borke et al. relates to crosslinkable flame retardant wire and cable compositions having improved abrasion resistance. The compositions are comprised of a high density silane-containing polyethylene base resin which can be a blend of a bimodal HDPE and ethylene-silane copolymer or silane-grafted bimodal HDPE in combination with a flame retardant and silanol condensation catalyst.

EP 2 889 323 A1 to S. Deveci et al. relates to a polymer composition comprising carbon black and a carrier polymer for the carbon black. A masterbatch comprising, preferably consisting of, (I) 20-50 wt % pigment based on the total amount of the masterbatch (100 wt %); (II) at least 40 wt % of at least one carrier polymer which is a multimodal high density polyethylene (HDPE) having an MFR₂ of 1 to 20 g/10 min, a density of 940 to 965 kg/m³ (pref 950 to 960) and a Mw/Mn of 5.5 to 20; and (IV) optionally further additives.

US 2008/0176981 A1 to M. Biscoglio et al. (BISCOGLIO) relates to a moisture-crosslinkable polymeric composition comprising (a) a silane-functionalized olefinic polymer, (b) an acidic silanol condensation catalyst, and (c) a secondary-amine-containing antioxidant composition. The antioxidant composition can be (1) a secondary amine substituted with two aromatic groups or (2) a combination of a first antioxidant and a secondary amine antioxidant substituted with at least one aromatic group. The moisture-crosslinkable polymeric composition can be used for making fibers, films, pipes, foams, and coatings. The compositions may be applied as a coating over a wire or a cable.

BISCOGLIO's moisture crosslinkable polymeric composition is prepared from a 2-part formulation consisting of an additive package in one part and the (a) silane-functionalized olefinic polymer, such as DFDB-5451 ethylene/silane copolymer, in another part [0037]. The additive package contains, among other constituents, a blended carrier resin of a low density polyethylene, such as the linear low density polyethylene DFH-2065, and an ethylene/ethyl acrylate copolymer, such as DPDA-6182, the (b) acidic silanol condensation catalyst, such as a sulfonic acid, and the (c) secondary amine [0037], [0038] and Table 1. The (c) secondary amine may be substituted with two aromatic groups [0005]. The DFDB-5451 is a host polymer that contains moisture curable silane groups. The moisture crosslinkable polymeric composition is prepared by extruding the additive package at 5 wt % into the DFDB-5451 [0037]. The moisture crosslinkable polymeric composition may be cured with water such as by exposing the composition at 23° C. and 70% relative humidity for two days [0039].

### SUMMARY

We (the present inventors) have discovered that standard additive masterbatch compositions that employ carrier resins composed of LDPE or EEA or EVA copolymers suffer from moisture pick-up. Moisture pick-up can lead to premature curing of moisture curable polyolefin compositions prepared therefrom or decomposition of moisture-sensitive additives. Prior flame retardant masterbatch compositions tend to rapidly absorb moisture from the environment, and thus to prevent this often are dried and sealed in bags composed of material having low water transmission rates (WTR), such as aluminum foil bags. Such sealing in aluminum foil bags is costly, and the sealed bags are difficult to transport without careful handling and have to be opened and used promptly by cable makers so as to avoid undesired moisture pickup.

We conceived a technical solution to this problem that inhibits or prevents moisture pickup by using a high density/high crystallinity polyethylene as a carrier for flame retardant additive. Surprisingly, not only can the high density/high crystallinity polyethylene hold high loading levels of flame retardant additive, the resulting masterbatch shows very low moisture pickup rate and beneficial resistance to scorch (premature curing) during extrusion of moisture curable polyolefin compositions containing same. The solution includes a semi-crystalline polyolefin-based additive masterbatch composition, as well as a moisture curable polyolefin composition prepared therewith, methods of making and using same, and articles containing or made from same.

### DETAILED DESCRIPTION

The Summary and Abstract are incorporated here by reference. Examples of embodiments include the following numbered aspects.

Aspect 1. An additive masterbatch composition comprising (A) a semi-crystalline polyolefin carrier resin and an additive package comprising (B) a flame retardant; wherein (A) is 10 to 90 weight percent (wt %), alternatively 10 to 70 wt %, alternatively 10 to 60 wt %, alternatively 10 to 50 wt %, and the additive package is from 90 to 10 wt %, alternatively 90 to 30 wt %, alternatively 90 to 40 wt %, alternatively 90 to 50 wt %, of total weight (100.00 wt %) of the additive masterbatch composition.

Aspect 2. The additive masterbatch composition of aspect 1 wherein the (A) semi-crystalline polyolefin carrier resin consists essentially of, alternatively consists of any one of (i) to (viii): (i) a semi-crystalline medium density polyethylene; (ii) a semi-crystalline high density polyethylene; (iii) a semi-crystalline polypropylene; (iv) a semi-crystalline ethylene/propylene copolymer; (v) a semi-crystalline poly(ethylene-co-alpha-olefin) copolymer; (vi) a combination (e.g., mixture or blend) of any two or more of (i), (ii) and (v); (vii) the (A) semi-crystalline polyolefin carrier resin has a crystallinity of 50 to <100 wt %, alternatively 55 to <100 wt %, alternatively 60 to <100 wt %, alternatively 65 to <100 wt %; or (viii) any one of limitations (i) to (vi) and the (A) semi-crystalline polyolefin carrier resin has a crystallinity of 50 to <100 wt %, alternatively 55 to <100 wt %, alternatively 60 to <100 wt %, alternatively 65 to <100 wt %.

Aspect 3. The additive masterbatch composition of aspect 1 or 2 wherein the (A) semi-crystalline polyolefin carrier resin has any one of (i) to (x): (i) a density of at least 0.925 g/cm³ and is a polyethylene or a density of 0.89 to 0.90 g/cm³ and is a polypropylene; (ii) a crystallinity of 50 to <100 wt %, alternatively 55 to <100 wt %, alternatively 60 to <100 wt %, alternatively 65 to <100 wt % and is a polyethylene; (iii) a melt flow index (MFI) of 0.1 to 50 grams per 10 minutes (g/10 min.), alternatively 0.5 to 50 g/10 min., alternatively 0.5 to 20 g/10 min., all at 190° C./2.16 kg load and is a polyethylene or a melt flow rate (MFR) of 0.5 to 50 g/10 min. at 230 C./2.16 kg load and is a polypropylene; (iv) a molecular weight distribution (MWD) that is monomodal; (v) a MWD that is bimodal; (vi) both (i) and (ii); (vii) both (i) and (iii); (viii) both (ii) and (iii); (ix) both (iv) and at least one of (i) to (iii); or (x) both (v) and at least one of (i) to (iii).

Aspect 4. The additive masterbatch composition of any one of aspects 1 to 3 wherein the (B) flame retardant is (B1) a mineral, (B2) an organohalogen compound, (B3) an (organo)phosphorous compound; (B4) a halogenated silicone; or a combination of any two or more thereof.

Aspect 5. The additive masterbatch composition of any one of aspects 1 to 4 further comprising at least one additive selected from: (C) an acidic condensation catalyst; (D) a secondary diarylamine of formula (I): (R¹—Ar)₂NH (I), wherein each Ar is benzene-1,4-diyl or both Ar are bonded to each other and taken together with the NH of formula (I) constitute a carbazol-3,6-diyl; and each R¹ is independently (C₁-C₂₀)hydrocarbyl; (E) one or two second antioxidants, each having a structure different than formula (I) and each other; (F) a processing aid; (G) a colorant; (H) a metal deactivator; (I) an (unsaturated carbon-carbon bond)-free hydrolyzable silane; (J) a corrosion inhibitor; (K) a product of a reaction of (C) and (D); (L) a hindered amine light stabilizer; and (M) a combination of (K) and any two or more of additives (C) to (J) and (L). When the additive masterbatch composition further comprises the (K) product of a reaction of (C) and (D), in some aspects is any one of (i) to (iv): (i) the product of a reaction of (C) and (D) comprises a salt formed by an acid/base reaction of (C) and (D); (ii) the additive package further comprises unreacted (C) but not unreacted (D); (iii) the additive package further comprises unreacted (D) but not unreacted (C); or (iv) the additive package further comprises unreacted (C) and unreacted (D). In some aspects at least 50 wt %, alternatively at least 75 wt %, alternatively at least 90 wt % of the combined weight of (C) and (D) is the product of a reaction of (C) and (D).

Aspect 6. A moisture-curable polyolefin composition comprising the additive masterbatch composition of any one of aspects 1 to 5 and a (hydrolyzable silyl group)-functional polyolefin prepolymer; wherein in the (hydrolyzable silyl group)-functional polyolefin prepolymer: (i) each hydrolyzable silyl group is independently a monovalent group of formula (II): (R²)ₘ(R³)₃₋ₘSi— (II); wherein subscript m is an integer of 1, 2, or 3; each R² is independently H, HO—, (C₁-C₆)alkoxy, (C₂-C₆)carboxy, ((C₁-C₆)alkyl)₂N—, (C₁-C₆)alkyl(H)C═NO—, or ((C₁-C₆)alkyl)₂C═NO—; and each R³ is independently (C₁-C₆)alkyl or phenyl; (ii) the polyolefin is polyethylene based, poly(ethylene-co-(C₃-C₄₀)alpha-olefin)-based, or a combination thereof; or (iii) both (i) and (ii). Aspect 7 is any one of (i) to (iii).

Aspect 7. A method of making a moisture-curable polyolefin composition, the method comprising mixing a (hydrolyzable silyl group)-functional polyolefin prepolymer and a divided solid form of the additive masterbatch composition of any one of aspects 1 to 5 so as to give a mixture; and melting or extruding the mixture so as to make the moisture-curable polyolefin composition.

Aspect 8. A moisture-cured polyolefin composition that is a product of moisture curing the moisture curable polyolefin composition of aspect 6, or the composition made by the method of aspect 7, to give the moisture-cured polyolefin composition.

Aspect 9. A manufactured article comprising a shaped form of the moisture-cured polyolefin composition of aspect 8.

Aspect 10. A coated conductor comprising a conductive core and a polymeric layer at least partially surrounding the conductive core, wherein at least a portion of the polymeric layer comprises the moisture-cured polyolefin composition of aspect 8.

Aspect 11. A method of conducting electricity, the method comprising applying a voltage across the conductive core of the coated conductor of aspect 10 so as to generate a flow of electricity through the conductive core.

Additive masterbatch composition. The additive masterbatch composition may contain at least 45 wt %, alternatively at least 50 wt %, alternatively at least 55 wt %, alternatively at least 70 wt %, alternatively at least 80 wt %, alternatively at least 90 wt % of the (A) semi-crystalline polyolefin carrier resin; all based on total weight of the additive masterbatch composition. The additive masterbatch composition may contain from 55 to 1 wt %, alternatively 50 to 1 wt %, alternatively 45 to 1 wt %, alternatively 30 to 1 wt %, alternatively 20 to 1 wt %, alternatively 10 to 1 wt % of the (B) flame retardant. The additive masterbatch composition may be free of: (i) an ethylene/silane copolymer, (ii) an ethylene/vinyl acetate (EVA) copolymer, (iii) an ethylene/alkyl acrylate copolymer (e.g., EEA copolymer), (iv) carbon black; (v) a pigment or colorant; (vi) a filler; (vii) any two, alternatively any six of (i) to (vi). The additive masterbatch composition may have from >0 to 5 wt % of any other carrier resin such as a low density polyethylene (LDPE), a linear low density polyethylene (LLDPE), an ethylene/alpha-olefin copolymer, an EEA copolymer, a polypropylene, a nylon (e.g., Nylon 6 or 66), a BPA-PC, a polycarbonate, a BPA-PS, a polysulfone, or a polyphenylene oxide; alternatively the additive masterbatch composition may be free of any carrier resin, or any resin, other than the (A) semi-crystalline polyolefin carrier resin.

The additive masterbatch composition may further comprise the (G) colorant and may be characterized as a color masterbatch composition. The (G) colorant may be a pigment (e.g., carbon black or titanium dioxide), a dye, or a phosphor; alternatively titanium dioxide or a phosphor. The color masterbatch composition may be free of a HDPE.

The additive masterbatch composition may further comprise a filler and may be characterized as a filler masterbatch composition. The filler may be calcium carbonate, zinc borate, zinc molybdate, zinc sulfide, carbon black, talc, magnesium oxide, zinc oxide, or a clay. Alternatively, the filler masterbatch composition may be free of a HDPE.

Alternatively, the additive masterbatch composition may be free of (i) (G) colorant, (ii) filler, (iii) both (i) and (ii).

Constituent (A) semi-crystalline polyolefin carrier resin. The semi-crystalline polyolefin carrier resin may be a semi-crystalline polyethylene that is a semi-crystalline medium density polyethylene (MDPE), a semi-crystalline high density polyethylene (HDPE), or a combination thereof.

The (A) semi-crystalline polyolefin carrier resin may have a density of at least 0.925 g/cm³, alternatively at least 0.930 g/cm³, alternatively at least 0.935 g/cm³, alternatively at least 0.940 g/cm³. The semi-crystalline HDPE may have a maximum density of 0.970 g/cm³, alternatively at most 0.960 g/cm³, alternatively at most 0.950 g/cm³. The semi-crystalline HDPE may have a density of from 0.930 to 0.970 g/cm³, alternatively 0.935 to 0.965 g/cm³. The density of the (A) may be measured by ASTM D-1505, Test Method for Density of Plastics by the Density-Gradient Technique.

The (A) semi-crystalline polyolefin carrier resin may have a crystallinity of at least 55 wt %, alternatively at least 58 wt %, alternatively at least 59 wt %. In any one of the immediately preceding aspects the crystallinity may be at most 90 wt %, alternatively at most 80 wt %, alternatively at most 78 wt %. In some aspects the crystallinity is from 55 to 80 wt %, alternatively from 58 to 78 wt %, alternatively from 58 to 76 wt %, alternatively from 62 to 78 wt %, alternatively any one of 59±1 wt %, 62±1 wt %, 76±1 wt %, and 77±1 wt %. The crystallinity of a semi-crystalline polyolefin resin, such as (A) semi-crystalline polyolefin carrier resin, may be determined by differential scanning calorimetry (DSC) according to ASTM D3418-15 or the Crystallinity Test Method described later. For a semi-crystalline polyethylene resin, wt % crystallinity=(ΔH_{f}*100%)/292 J/g. For a semi-crystalline polypropylene resin, wt % crystallinity=(ΔH_{f}*100%)/165 J/g. In the respective equations ΔH_{f} is the second heating curve heat of fusion for the polyethylene resin or polypropylene resin, as the case may be, * indicates mathematical multiplication, / indicates mathematical division, 292 J/g is a literature value of the heat of fusion (ΔH_{f}) for a 100% crystalline polyethylene, and 165 J/g is a literature value of the heat of fusion (ΔH_{f}) for a 100% crystalline polypropylene. Preferably, crystallinity is determined by DSC according to the Crystallinity Test Method described later.

The (A) semi-crystalline polyolefin carrier resin may have a melt flow index (MFI) of 10 to 20 g/10 min., alternatively 0.1 to 10 g/10 min., alternatively 0.20 to 9 g/10 min. The MFI may be determined by ASTM D1238 (2.16 kilograms (kg), 190° C.)

The (A) semi-crystalline polyolefin carrier resin may be characterized by a molecular weight distribution (MWD) that is monomodal, alternatively bimodal.

The (A) semi-crystalline polyolefin carrier resin may be a semi-crystalline HDPE that is bimodal and has a density of from 0.950 to 0.958 g/cm³ and a MFI of from 0.20 to 0.40 g/10 min. The (A) semi-crystalline polyolefin carrier resin may be a semi-crystalline HDPE that is monomodal and has a density of from 0.930 to 0.970 g/cm³ and a MFI of from 0.65 to 9 g/10 min., alternatively a density from 0.935 to 0.965 g/cm³ and a MFI from 0.7 to 8.5 g/10 min.

Constituent (B) flame retardant. The (B) flame retardant is a compound that inhibits or delays the spread of fire by suppressing chemical reactions in a flame. The (B) may be the (B1) mineral, (B2) organohalogen compound, (B3) (organo)phosphorous compound; (B4) a halogenated silicone; (B5) a manufactured material; or a combination of any two or more thereof. In some aspects the (B) is (B1), alternatively (B2), alternatively (B3), alternatively (B4), alternatively (B5), alternatively a combination of (B1) and at least one of (B2) to (B5).

In some aspects the (B) flame retardant may be a halogen-free flame retardant. The halogen-free flame retardant may be a halogen-free embodiment of the (B1) mineral, a halogen-free embodiment of the (B3) (organo)phosphorous compound, a halogen-free embodiment of the (B5) manufactured material, or any other halogen-free (B) flame retardant material. The halogen-free flame retardant may be uncoated or comprise a surface-coating material on the surface thereof. The surface-coating material may be a saturated or unsaturated carboxylic acid having from 8 to 24 carbon atoms, alternatively 8 to 18 carbon atoms, alternatively 12 to 24 carbon atoms, alternatively 12 to 18 carbon atoms; or a metal carboxylate salt thereof. Surface treatments and coating materials are known, e.g., U.S. Pat. Nos. 4,255,303; 5,034,442; 7,514,489; US 2008/0251273 A1; and US 2015/0004343 A1.

In some aspects the (B) flame retardant comprises, or consists of, the (B1) mineral. The (B1) may be amorphous or crystalline. The (B1) mineral may be a metal hydroxide, an alumina, ammonium octamolybdate, an antimony trioxide, a calcium carbonate, a clay, a mica, an organo-modified clay, a red phosphorous, a silica, a talc, a titanium oxide, a wollastonite, or a zinc borate. The metal hydroxide may be an aluminum hydroxide such as aluminum trihydroxide, a calcium hydroxide, or a magnesium hydroxide, or a combination of any two or more thereof. In some aspects the additive masterbatch composition comprises the (B1) mineral and further comprises a flame retardant synergist compound. The flame retardant synergist compound is an additive that enhances (increases) flame retarding properties of the (B1) mineral and is distinct from the (B1) mineral in at least one aspect such as composition or function. Flame retardant synergist compounds are useful as additives in wire and cable insulation formulations. An example of a flame retardant synergist compound is antimony trioxide.

In some aspects the (B) flame retardant comprises, or consists of, the (B2) organohalogen compound. The (B2) may contain on average per molecule 1, 2, 3, or more halogen atoms bonded to carbon atom(s). When all C—H bonds are formally replaced by C-halogen bonds in the (B2) organohalogen compound, the (B2) is a perhalogenated organic compound. Each halogen of (B2) independently may be F, Cl, Br, or I; alternatively F, Cl, or Br; alternatively F or Cl; alternatively F or Br; alternatively Cl or Br; alternatively F; alternatively Cl; alternatively Br.

In some aspects each halogen of (B2) is a chlorine atom. Examples of such (B2) are perchloropentacyclodecane; Diels-Alder adducts of hexachlorocyclopentadiene with “enes” such as maleic anhydride; tetrachlorobisphenol A; tetrachlorophthalic anhydride; and hexachloroendomethylenetetrahydrophthalic acid.

In some aspects each halogen of (B2) is a bromine atom (Br). In some aspects (B2) is an organobromine compound, alternatively a perbrominated organic compound, which are not oligomers or polymers. In some aspects the organobromine compound is a decabromodiphenylethane; a N,N′-ethylenebis(3,4,5,6-tetrabromophthalimide); hexabromobenzene; pentabromoethylbenzene 2,4,6-tribromophenol; tribromophenyl allyl ether; octaobromodiphenyl; poly(pentabromobenzyl)acrylate; pentabromodiphenyl ether; octabromodiphenyl ether; decabromodiphenyl ether; tetrabromobisphenol A; bis(dibromopropyl)ether of tetrabromobisphenol A; tetrabromophthalic anhydride; ethylene-bis(tetrabromophthalimide); and hexabromocyclododecane.

In some aspects the (B) flame retardant comprises, or consists of, (B2) that is a poly(bromo-substituted organic monomer) polymer. Examples of the poly(bromo-functional organic monomer) polymers are a poly(monobromostyrene); a poly(vinyl bromide); a poly(vinylidene bromide); a poly(bromo-alkyl acrylate) such as poly(2-bromoethyl methacrylate) and poly(2,3-dibromopropyl methacrylate); a poly(alkyl bromo-acrylate) such as poly(methyl-α-bromoacrylate). Examples of the poly(monobromostyrene) are poly(4-bromostyrene) and poly(2-bromostyrene). Examples of the poly(bromo-alkyl acrylate) are a poly(2-bromoethyl methacrylate) and a poly(2,3-dibromopropyl methacrylate.

In some aspects the (B) flame retardant comprises, or consists of, (B2) that is a brominated poly(organic monomer) polymer. The brominated poly(organic monomer) polymer is formed by brominating a poly(organic monomer) polymer. Examples of the brominated poly(organic monomer) polymer are brominated polystyrene; brominated natural and synthetic rubber; brominated butadiene styrene copolymer; brominated poly(organic monomer) polymer of WO 2014/014648 A2; brominated poly(organic monomer) polymers of U.S. Pat. No. 5,066,752; brominated organic polymer of Polymer Degradation and Stability, 1989; 25(1):1-9; and brominated (butadiene/vinylarene monomer) copolymers such as a brominated styrene/butadiene random copolymer or a brominated styrene/butadiene block copolymer (Br-SBC), such as Emerald Innovation™ 3000 having Mw greater than (>) 100,000 g/mol and CAS No. 1195978-93-8. Suitable brominated (butadiene/vinylarene monomer) copolymers, including BR-SBC, and processes for their synthesis are found in U.S. Pat. No. 7,851,558 B2.

The (B2) that is a poly(bromo-substituted organic monomer) polymer or a brominated poly(organic monomer) polymer independently may have a weight average molecular weight (Mw) of greater than or equal to (≥) 1,000 grans per mole (g/mol), alternatively 10,000 g/mol, alternatively ≥25,000 g/mol, alternatively ≥50,000 g/mol, alternatively 100,000 g/mol; and in some aspects Mw less than (<) 2,000,000 g/mol, alternatively <1,000,000 g/mol; alternatively <500,000 g/mol.

Examples of other halogenated compounds useful as (B2) are found in U.S. Pat. No. 6,936,655.

In some aspects the (B) flame retardant comprises, or consists of, the (B3) an (organo)phosphorous compound. The term “(organo)phosphorous” indicates that (B3) may be a phosphorous compound, an organophosphorous compound, or a combination of any two or more thereof. Examples of the (B3) are organic phosphonic acids, phosphonates, phosphinates, phosphonites, phosphinites, phosphine oxides, phosphines, phosphites or phosphates, phosphorus ester amides, phosphoric acid amides, phosphonic acid amides, phosphinic acid amides, and a combination of any two or more thereof. The (B3) optionally may be intumescent. Additional examples of (B3) are phenylbisdodecyl phosphate, phenylbisneopentyl phosphate, phenyl ethylene hydrogen phosphate, phenyl-bis-3,5,5′-trimethylhexyl phosphate), ethyldiphenyl phosphate, 2-ethylhexyl di(p-tolyl)phosphate, diphenyl hydrogen phosphate, bis(2-ethyl-hexyl)p-tolylphosphate, tritolyl phosphate, bis(2-ethylhexyl)-phenyl phosphate, tri(nonylphenyl)phosphate, phenylmethyl hydrogen phosphate, di(dodecyl)p-tolyl phosphate, tricresyl phosphate, triphenyl phosphate, dibutylphenyl phosphate, p-tolyl bis(2,5,5′-trimethylhexyl)phosphate, 2-ethylhexyldiphenyl phosphate, and diphenyl hydrogen phosphate. In some aspects the (B3) is bisphenol-A bis(diphenyl phosphate), resorcinol bis(diphenyl phosphate), or cresol bis(diphenyl phosphate.

In some aspects the (B) flame retardant comprises, or consists of, the (B4) halogenated silicone. Each halogen of (B4) independently may be F, Cl, Br, or I; alternatively F, Cl, or Br; alternatively F or Cl; alternatively F or Br; alternatively Cl or Br; alternatively F; alternatively Cl; alternatively Br. In some aspects each halogen of (B4) is a bromine atom (Br). Examples of the halogenated silicone are halogenated silicone rubber, DOW CORNING 11-100 Additive, and DOW CORNING 4-7081 Resin Modifier.

In some aspects the (B) flame retardant comprises, or consists of, the (B5) manufactured material. The (B5) may be a fritted material, silicate glass microspheres (hollow or solid), an expanded graphite, carbon nanotubes, or a combination of any two or more thereof.

In some aspects the (B) flame retardant comprises, or consists of, the combination of any two or more of (B1) to (B5). In some aspects (B) is a combination of (B1) and (B2); alternatively (B1) and (B3); alternatively (B1) and (B4); alternatively (B2) and (B3); alternatively (B2) and (B4); alternatively (B3) and (B4); alternatively (B1) and (B5); alternatively (B1) and at least two of (B2) to (B5).

In some aspects the (B) flame retardant is an aluminum hydroxide, a magnesium hydroxide, a calcium carbonate, a combination of any two thereof, or all three. The (B) flame retardant may be an alumina, an aluminum trihydroxide, an antimony trioxide, a calcium carbonate, a calcium hydroxide, a clay (e.g., a nano-clay), a magnesium dihydroxide, an organo-modified clay, a silica, a talc, a titanium oxide, a wollastonite, a zinc borate, or a combination of any two or more thereof.

In some aspects the (B) flame retardant may be at least 1 wt %, alternatively at least 10 wt %, alternatively at least 25 wt %, alternatively at least 35 wt %, alternatively at least 45 wt %; and at most 60 wt %, alternatively at most 50 wt %, alternatively at most 45 wt % of the additive masterbatch composition.

Optional constituent (additive) (C) acidic condensation catalyst. The constituent (C) is suitable for condensation curing the hydrolyzable silyl groups of the (A) (hydrolyzable silyl group)-functional polyolefin prepolymer. The (C) may be a Lewis acid, alternatively a Brønsted acid, alternatively a combination of a Lewis acid and a Brønsted acid. As used herein “Lewis acid” means a molecule or ion that is an electron pair acceptor in neutral water to give a potential of hydrogen (pH) of 6.9 or lower. As used herein “Brønsted acid” means a molecule that is a proton (H⁺) donor in neutral water to give a potential of hydrogen (pH) of 6.9 or lower. In some aspects (C) is any one of Brønsted acids (i) to (vii): (i) an organosulfonic acid, an organophosphonic acid, or a hydrogen halide; (ii) an organosulfonic acid; (iii) an alkyl-substituted arylsulfonic acid; (iv) an alkyl-substituted arylsulfonic acid wherein there is/are 1 or 2 (C₅-C₂₀)alkyl substituent(s) and 1 aryl group that is phenyl or naphthyl; (v) a (C₁-C₅)alkylphosphonic acid, wherein the (C₁-C₅)alkyl is unsubstituted or substituted with one —NH₂ group; (vi) HF, HCl, or HBr; or (vii) a combination of any two or more of (i) to (vi). In some aspects the (C) is an organosulfonic acid. Examples of suitable organosulfonic acids are 4-methylphenylsulfonic acid, dodecylbenzenesulfonic acid, alkylnaphthylsulfonic acids, and organosulfonic acids in WO 2006/017391; EP 0736065; and U.S. Pat. No. 6,441,097. In some aspects (C) is any one of Lewis acids (i) to (v): (i) a transition metal-carboxylate compound or a transition metal-halide compound, wherein the transition metal is an element of any one of Groups 3 to 13 of the Periodic Table of the Elements and each halide is Cl or Br; (ii) the transition metal-carboxylate compound; (iii) the transition metal-carboxylate compound wherein the transition metal is tin, zinc, copper, iron, lead, or titanium; (iv) the transition metal-carboxylate compound wherein each carboxylate independently is a (C₁-C₃₀)alkylcarboxylate, alternatively a (C₅-C₃₀)alkylcarboxylate, alternatively a (C₁₀-C₃₀)alkylcarboxylate, alternatively a (C₁₀-C₂₀)alkylcarboxylate, alternatively a (C₁₀-C₁₈)alkylcarboxylate; and (v) dibutyltin dilaurate.

The (C) may be present in the moisture-curable polyolefin composition at a concentration from 0.01 to 0.50 wt %, alternatively at least 0.05 wt %, alternatively at least 0.10 wt %; and alternatively at most 0.3 wt %, alternatively at most 0.2 wt %; all based on total weight of the moisture-curable polyolefin composition.

Optional constituent (additive) (D) secondary diarylamine of formula (I): (R¹—Ar)₂NH (I), wherein Ar and R¹ are as defined above. (D) may function as an antioxidant. In some aspects of the (D) secondary diarylamine of formula (I): (i) each Ar is benzene-1,4-diyl; (ii) both Ar are bonded to each other and taken together with the NH of formula (I) constitute a carbazol-3,6-diyl; (iii) each R¹ is independently (C₁-C₁₀)hydrocarbyl; (iv) each R¹ is independently (C₇-C₂₀)hydrocarbyl; (v) each R¹ is independently benzyl, 1-phenylethyl, or 1-methyl-1-phenylethyl; (vi) 1-methyl-1-phenylethyl; (vii) both (i) and any one of (iii) to (vi); or (viii) both (ii) and any one of (iii) to (vi).

Examples of suitable constituent (D) are 3,6-dibenzylcarbazole; bis(4-benzylphenyl)amine, bis(4-(1-phenylethyl)phenyl)amine, and bis(4-(1-methyl-1-phenylethyl)phenyl)amine. In some aspects of the moisture-curable polyolefin composition, the concentration of constituent (D) is greater than, alternatively at least 1.1 times (1.1 x) greater than, alternatively at least 1.2×greater than, alternatively at least 1.3×greater than the concentration of any acidic condensation catalyst. In such aspects of the moisture-curable polyolefin composition, the concentration of constituent (D) is less than 1.6 x, alternatively less than 1.5×, alternatively less than 1.4×the concentration of acidic condensation catalyst.

Optional constituent (additive) (E) one or two second antioxidants. Each of the one or two (E) independently have a structure that is different than that of formula (I) and each other. In some aspects constituent (E) is 1 second antioxidant. In other aspects constituent (E) is two second antioxidants. Examples of suitable second antioxidants are polymerized 1,2-dihydro-2,2,4-trimethylquinoline (Agerite MA); tris(4-tert-butyl-3-hydroxy-2,6-dimethylbenzyl)-s-triazine-2,4,6-(1H,3H,5H)trione (Cyanox 1790); distearyl-3,3-thiodiproprionate (DSTDP); tetrakismethylene (3,5-di-tert-butyl-4-hydroxyhydrocinnamate) methane (Irganox 1010); 1,2-bis(3,5-di-tert-butyl-4-hydroxyhydrocinnamoyl)hydrazine (Irganox 1024); bis(4,6-dimethylphenyl)isobutylidene (Lowinox 221646); and 4,4-thiobis(2-tert-butyl-5-methylphenol) (TBM6). To remove all doubt, the additive masterbatch composition and moisture-curable polyolefin composition independently may further comprise (D), but not (E); alternatively may further comprise (E) but not (D); alternatively may further comprise (D) and (E).

Optional constituent (additive) (F) processing aid. Constituent (F) may improve flow of a melt of the additive masterbatch composition through a machine. (F) may be an organic processing aid such as a fluoropolymer or a silicone processing aid such as a polyorganosiloxane or fluoro-functionalized polyorganosiloxane. The constituent (F) may be used at a concentration of from 1 to 20 wt %, alternatively 2 to 18 wt %, alternatively 3 to 15 wt %, based on total weight of the additive masterbatch composition.

Optional constituent (additive) (G) a colorant. E.g., a pigment or dye. E.g., carbon black or titanium dioxide. The carbon black may be provided as a carbon black masterbatch that is a formulation of poly(l-butene-co-ethylene) copolymer (from ≥95 wt % to <100 wt % of the total weight of the masterbatch) and carbon black (from >0 wt % to ≤5 wt % of the total weight of the masterbatch. The (G) colorant may be from 0.1 to 35 wt %, alternatively 1 to 10 wt %, based on total weight of the moisture-curable polyolefin composition.

Optional constituent (additive) (H) a metal deactivator. E.g., oxaylyl bis(benzylidene hydrazide) (OABH). Constituent (H) may be from 0.001 to 0.2 wt %, alternatively 0.01 to 0.15 wt %, alternatively 0.01 to 0.10 wt %, all based on total weight of the moisture-curable polyolefin composition.

Optional constituent (additive) (1) (unsaturated carbon-carbon bond)-free hydrolyzable silane. Useful for scavenging moisture. Constituent (1) may be any monosilane containing at least 1, alternatively at least 2, alternatively at least 3, alternatively 4 hydrolyzable groups (e.g., R² as defined above); and at most 3, alternatively at most 2, alternatively at most 1, alternatively 0 non-hydrolyzable (unsaturated carbon-carbon bond)-free groups such as alkyl or aryl groups. Examples of (1) are acetoxytrimethylsilane, 4-benzylphenylsulfonoxytributylsilane, dimethylamino-methoxy-dioctylsilane, octyltrimethoxysilane, and tetramethoxysilane. Constituent (1) may be from 0.1 to 2 wt %, alternatively 0.1 to 1.5 wt %, alternatively 0.1 to 1.0 wt %; all based on total weight of the moisture-curable polyolefin composition.

Optional constituent (additive) (J) a corrosion inhibitor. E.g., tin (II) sulfate. Constituent (J) may be from 0.00001 to 0.1 wt %, alternatively 0.0001 to 0.01 wt %, based on total weight of the moisture-curable polyolefin composition.

Optional constituent (additive) (L) hindered amine light stabilizer. The (L) is a compound that inhibits oxidative degradation. Examples of suitable (L) are butanedioic acid dimethyl ester, polymer with 4-hydroxy-2,2,6,6-tetramethyl-1-piperidine-ethanol (CAS No. 65447-77-0, commercially LOWILITE 62); and poly[[6-[(1,1,3,3-tetramethylbutyl)amino]-1,3,5-triazine-2,4-diyl](2,2,6,6-tetramethyl-4-piperidinyl)imino]-1,6 hexanediyl[(2,2,6,6-tetramethyl-4-piperidinyl)imino]]) (CAS 71878-19-8/70624-18-9. Chimassorb 994 LD, BASF).

Optional constituents (additives) (M) a combination of (K) and any two or more of additives (C) to (J) and (L). In some aspects the additive masterbatch composition may comprise carrier resin (A) and an additive package comprising (B), (K), (E) and (L).

The additive masterbatch composition may further comprise other optional constituents (additives) selected from a lubricant and an anti-blocking agent.

Moisture-curable polyolefin composition. The total weight of all constituents and additives in the moisture-curable polyolefin composition is 100.00 wt %. The moisture-curable polyolefin composition may further comprise water. The additive masterbatch composition may be at a concentration of from 0.1 to 10 wt %, alternatively from 0.5 to 7 wt %, alternatively from 1 to 6 wt %, of the moisture-curable polyolefin composition; all based on total weight of the moisture-curable polyolefin composition.

The moisture-curable polyolefin composition may be a one-part formulation, alternatively a two-part formulation. The two-part formulation may comprise first and second parts, wherein the first part consists essentially of a (hydrolyzable silyl group)-functional polyolefin prepolymer; wherein the second part consists essentially of the additive masterbatch composition.

In some aspects of the moisture-curable polyolefin composition, the divided solid form of the additive master batch composition may comprise granules and/or pellets. Prior to the mixing step used to prepare the moisture-curable polyolefin composition, the (hydrolyzable silyl group)-functional polyolefin prepolymer also may be in a divided solid form (e.g., granules or pellets).

In some aspects of the moisture-curable polyolefin composition, the additive masterbatch composition may further comprise constituents (D) and (E) and the amount of the additive masterbatch composition used may be such that the (D), or the ad rem portion of the (K) product of reaction prepared from (C) and (D), is (i) from >0.200 weight percent (wt %) to 0.500 wt %; (ii) from 0.220 wt % to 0.500 wt %, (iii) from 0.250 wt % to 0.50 wt %, or (iv) from 0.220 wt % to 0.40 wt %; all based on total weight of the moisture-curable polyolefin composition.

The (hydrolyzable silyl group)-functional polyolefin prepolymer (“Host Polymer”). The polyolefin of the Host Polymer may be polyethylene based, which means that the prepolymer has a backbone formed by polymerization of ethylene. Alternatively, the Host Polymer may be poly(ethylene-co-(C₃-C₄₀)alpha-olefin)-based, which means that the prepolymer has a backbone formed by copolymerization of ethylene and at least one alpha-olefin. Host Polymer may be a reactor copolymer of ethylene and an alkenyl-functional hydrolyzable silane. The alkenyl-functional hydrolyzable silane may be of formula (III) (R²)ₘ(R³)₃₋ₘSi—(C₂-C₆)alkenyl (III), wherein m, R², and R³ are as defined above for formula (II). The (C₂-C₆)alkenyl may be vinyl, allyl, 3-butenyl, or 5-hexenyl. In some aspects the Host Polymer is a reactor copolymer of ethylene and vinyltrimethoxysilane. Vinyltrimethoxysilane is an example of the alkenyl-functional hydrolyzable silane of formula (III) wherein subscript m is 3, each R² is a (C₁-C₆)alkoxy, specifically methoxy; and the (C₂-C₆)alkenyl is vinyl (—C(H)═CH₂). Alternatively, Host Polymer may be a reactor copolymer of ethylene, an alpha-olefin, and the alkenyl-functional hydrolyzable silane, such as in U.S. Pat. No. 6,936,671. Alternatively, Host Polymer may be a homopolymer of ethylene having a carbon atom backbone having the hydrolyzable silyl groups grafted thereonto, such as a polymer made by a process (e.g., a SIOPLAS™ process) comprising reactively grafting a hydrolyzable unsaturated silane (e.g., vinyltrimethoxysilane) in a post-polymerization compounding or extruding step, typically facilitated by a free radical initiator such as a dialkyl peroxide, and isolating the resulting silane-grafted polymer. The grafted polymer may be for used in a subsequent fabricating step. Alternatively, Host Polymer may be a copolymer of ethylene and one or more of (C₃-C₄₀)alpha-olefins and unsaturated carboxylic esters (e.g., (meth)acrylate alkyl esters), wherein the copolymer has a backbone having the hydrolyzable silyl groups grafted thereonto, such as made by a SIOPLAS™ process. Alternatively, Host Polymer may be a mixture of ethylene, a hydrolyzable silane such as the alkenyl-functional hydrolyzable silane of formula (III), and a peroxide suitable for use in a process (e.g., a MONOSIL™ process) comprising reactively grafting a hydrolyzable unsaturated silane (e.g., vinyltrimethoxysilane) in a post-polymerization compounding or extruding step, typically facilitated by a free radical initiator such as a dialkyl peroxide, and using the resulting silane-grafted polymer immediately (without isolation) in a subsequent fabricating step. Alternatively, Host Polymer may be a mixture of a copolymer of ethylene and one or more of (C₃-C₄₀)alpha-olefins and unsaturated carboxylic esters, a hydrolyzable silane such as the alkenyl-functional hydrolyzable silane of formula (III), and a peroxide, suitable for use in a SIOPLAS™ or MONOSIL™ process. The alpha-olefin may be a (C₃-C₄₀)alpha-olefin, alternatively a (C₃-C₂₀)alpha-olefin, alternatively a (C₃-C₁₀)alpha-olefin. The alpha-olefin may have at least four carbon atoms (i.e., be a (C₄)alpha-olefin or larger). Examples of the (C₃-C₁₀)alpha-olefin are propylene, 1-butene, 1-hexene, 1-octene, and 1-decene. The peroxide may be an organic peroxide such as described in WO 2015/149634 A1, page 5, line 6, to page 6, line 2. The organic peroxide, when present, may be used at a concentration of from 0.02 to 2 wt %, alternatively 0.04 to 2 wt %, alternatively 0.04 to 1 wt %, alternatively 0.04 to 0.08 wt %, based on total weight of the moisture-curable polyolefin composition. Host Polymer may be present in the moisture-curable polyolefin composition at a concentration from 40 to 99.78 wt %, alternatively at least 50 wt %, alternatively at least 60 wt %; and alternatively at most 99 wt %, alternatively at most 95 wt %, alternatively at most 80 wt %; all based on total weight of the moisture-curable polyolefin composition.

The (hydrolyzable silyl group)-functional polyolefin prepolymer (Host Polymer) may be: (i) a reactor copolymer of ethylene and a hydrolyzable silane; (ii) a reactor copolymer of ethylene, a hydrolyzable silane, and one or more alpha-olefins and unsaturated carboxylic esters (e.g., U.S. Pat. No. 6,936,671); (iii) a homopolymer of ethylene having a carbon backbone and a hydrolyzable silane grafted to the carbon backbone (e.g., made by the SILOPAS™ process); (iv) a copolymer of ethylene, one or more alpha-olefins and unsaturated carboxylic esters, having backbone and a hydrolyzable silane grafted to its backbone (e.g., made by the SILOPAS™ process); (v) a copolymer formed from a mixture of ethylene, hydrolyzable silane, and organic peroxide (e.g., made by the MONOSIL™ process); or (vi) a copolymer formed from a mixture of ethylene, and one or more alpha-olefins and unsaturated carboxylic esters, a hydrolyzable silane, and an organic peroxide (e.g., made by the MONOSIL™ process).

The additive masterbatch and moisture-curable polyolefin compositions may be referred to as unfilled compositions when fillers are absent therefrom. Aspects of the unfilled composition may be made by any suitable means. For example, an unfilled additive masterbatch composition that contains constituents (A) and (B), but does not contain filler, may be made in a Brabender batch mixer by blending the constituents for 3 minutes at 180° C. melt temperature using cam blades at 30 rotations per minute (rpm) to give an unfilled melt mixture, and then allowing the unfilled melt mixture to cool to give the embodiments of the unfilled composition.

The filler additive masterbatch composition and moisture-curable polyolefin composition prepared therefrom may be referred to as filled compositions. Embodiments of the filled compositions may also be made by any suitable means. For example, embodiments of the filled additive masterbatch composition may be made in a Brabender batch mixer using 180° C. melt temperature by first adding the constituents (A) and (B), and optionally (C) and/or (D), into the mixer. Once the constituents (A), (B), and, when present (C) and/or (D), have started melting, then add a filler, and optionally zero, one or more of additives(s) (E) one or two second antioxidants, followed by any other additives (F), (G), (H), (I), and/or (J), at flux to give a filled melt mixture. Then homogenize the filled melt mixture for about 3 minutes, and allow the filled melt mixture to cool to give the embodiments of the filler additive masterbatch composition.

Test samples of embodiments of unfilled and filled compositions may be separately made into compression molded plaques. The mechanical properties of these compositions may be characterized using test samples cut from the compression molded plaques.

Any compound herein includes all its isotopic forms, including natural abundance forms and/or isotopically-enriched forms. The isotopically-enriched forms may have additional uses, such as medical or anti-counterfeiting applications, wherein detection of the isotopically-enriched form is helpful in treatment or investigation.

The following apply unless indicated otherwise. Alternatively precedes a distinct embodiment. ASTM means the standards organization, ASTM International, West Conshohocken, Pa., USA. IEC means the standards organization, International Electrotechnical Commission, Geneva, Switzerland. Any comparative example is used for illustration purposes only and shall not be prior art. Free of or lacks means a complete absence of; alternatively not detectable. IUPAC is International Union of Pure and Applied Chemistry (IUPAC Secretariat, Research Triangle Park, N.C., USA). May confers a permitted choice, not an imperative. Operative means functionally capable or effective. Optional(ly) means is absent (or excluded), alternatively is present (or included). PPM are weight based. Properties are measured using a standard test method and conditions for the measuring (e.g., viscosity: 23° C. and 101.3 kPa). Ranges include endpoints, subranges, and whole and/or fractional values subsumed therein, except a range of integers does not include fractional values. Room temperature is 23° C.±1° C. Substituted when referring to a compound means having, in place of hydrogen, one or more substituents, up to and including per substitution.

Advantageously we discovered that the additive masterbatch composition is slow to pick up moisture. Thus, the additive masterbatch composition may have a shelf-life that is longer than a comparative composition that does not contain (A) before it is used to prepare the moisture-curable polyolefin composition. The moisture-curable polyolefin composition may be more resistant to moisture-induced scorch (premature curing) during extrusion thereof, such as during extrusion of the moisture-curable polyolefin composition as a coating on a cable such as a power cable, compared to compositions that do not contain the additive masterbatch composition. Also, the resulting extruded coating of the moisture-curable polyolefin composition may have moisture-induced lower porosity. Moisture-induced porosity can lead to failure of cables during electrical and/or mechanical testing. The moisture-cured polyolefin composition has satisfactory extent of crosslinking and has good heat aging performance under several different test conditions. Also, the moisture-cured polyolefin composition has good mechanical properties such as tensile strength and elongation-at-break. The additive masterbatch composition inhibits or prevents moisture pick-up and premature curing of moisture curable polyolefin compositions and/or decomposition of moisture-sensitive additives. The additive masterbatch composition may also inhibit or prevent phase separation or exudation of additive components. These characteristics make the moisture-cured polyolefin composition useful in a variety of applications including as a component of a coating of a coated conductor such as a coated wire or coated cable.

Additive Masterbatch Composition Preparation Methods. Melt blend constituents of the additive masterbatch compositions (of comparative and inventive examples) either in a Banbury compounder using a compounding temperature of 150° C., rotor speed of 30 rotations per minute (rpm). All resulting additive masterbatch compositions were dried at 70° C. for 24 hours before being used in moisture pickup studies or to prepare coated conductors.

Crystallinity Test Method. For determining crystallinity in wt % of a semi-crystalline polyolefin resin such as (A) semi-crystalline polyolefin carrier resin. Determine melting peaks and weight percent (wt %) crystallinity using DSC instrument DSC Q1000 (TA Instruments) as follows. (A) Baseline calibrate instrument. Use software calibration wizard. First obtain a baseline by heating a cell from −80° to 280° C. without any sample in an aluminum DSC pan. Then use sapphire standards as instructed by the calibration wizard. The analyze 1 to 2 milligrams (mg) of a fresh indium sample by heating the standards sample to 180° C., cooling to 120° C. at a cooling rate of 10° C./minute, then keeping the standards sample isothermally at 120° C. for 1 minute, followed by heating the standards sample from 120° to 180° C. at a heating rate of 10° C./minute. Determine that indium standards sample has heat of fusion (H_{f})=28.71±0.50 Joules per gram (J/g) and onset of melting=156.6°±0.5° C. Perform DSC measurements on test samples using same DSC instrument. For polyethylene test samples see procedure (B) below. For polypropylene test samples see procedure (C) below.

(B) DSC on Polyethylene Test Samples. Press test sample of polymer into a thin film at a temperature of 160° C. Weigh 5 to 8 mg of test sample film in DSC pan. Crimp lid on pan to seal pan and ensure closed atmosphere. Place sealed pan in DSC cell, equilibrate cell at 30° C., and heat at a rate of about 100° C./minute to 140° C., keep sample at 140° C. for 1 minute, cool sample at a rate of 10° C./minute to 0° C. or lower (e.g., −40° C.) to obtain a cool curve heat of fusion (H_{f}), and keep isothermally at 0° C. or lower (e.g., −40° C.) for 3 minutes. Then heat sample again at a rate of 10° C./minute to 180° C. to obtain a second heating curve heat of fusion (ΔH_{f}). Using the resulting curves, calculate the cool curve heat of fusion (J/g) by integrating from the beginning of crystallization to 10° C. Calculate the second heating curve heat of fusion (J/g) by integrating from 10° C. to the end of melting. Measure weight percent crystallinity (wt % crystallinity) of the polymer from the test sample's second heating curve heat of fusion (ΔH_{f}) and its normalization to the heat of fusion of 100% crystalline polyethylene, where wt % crystallinity=(ΔH_{f}*100%)/292 J/g, wherein ΔH_{f} is as defined above, * indicates mathematical multiplication, / indicates mathematical division, and 292 J/g is a literature value of heat of fusion (ΔH_{f}) for a 100% crystalline polyethylene.

(C) DSC on Polypropylene Test Samples. Press test sample of polypropylene into a thin film at a temperature of 210° C. Weigh 5 to 8 mg of test sample film in DSC pan. Crimp lid on pan to seal pan and ensure closed atmosphere. Place sealed pan in DSC cell and heat at a rate of about 100° C./minute to 230° C., keep sample at 230° C. for 5 minutes, cool sample at a rate of 10° C./minute to −20° C. to obtain a cool curve heat of fusion, and keep isothermally at −20° C. for 5 minutes. Then heat sample again at a rate of 10° C./minute until melting is complete to obtain a second heating curve heat of fusion ((ΔH_{f})). Using the resulting curves, calculate the cool curve heat of fusion (J/g) by integrating from the beginning of crystallization to 10° C. Calculate the second heating curve heat of fusion (J/g) by integrating from 10° C. to the end of melting. Measure weight percent crystallinity (wt % crystallinity) of the polymer from the test sample's second heating curve heat of fusion (ΔH_{f}) and its normalization to the heat of fusion of 100% crystalline polypropylene, where wt % crystallinity=(ΔH_{f}*100%)/165 J/g, wherein ΔH_{f} is as defined above, * indicates mathematical multiplication, / indicates mathematical division, and 165 J/g is a literature value of heat of fusion (ΔH_{f}) for a 100% crystalline polypropylene.

In other aspects the crystallinity is at room temperature of the semi-crystalline polyolefin (e.g., the semi-crystalline medium density polyethylene, semi-crystalline high density polyethylene, or the semi-crystalline poly(ethylene-co-alpha-olefin) copolymer (collectively “semi-crystalline ethylenic (co) polymer”)) and is calculated using the following equation.

$$Wt \% crystallinity = \frac{{ρ}_{c}}{ρ} ( \frac{ρ - {ρ}_{a}}{{ρ}_{c} - {ρ}_{a}} ) ,$$

wherein ρ=density of the semi-crystalline ethylenic (co) polymer (g/cm³ at 23 C.), ρₐ=density of amorphous fraction (0.855 g/cm³), and ρ_{c}=density of crystalline fraction (1.00 g/cm³). Determine melting peaks and percent (%) or weight percent (wt %) crystallinity of the semi-crystalline ethylenic (co) polymer using Differential Scanning calorimeter (DSC) instrument DSC Q1000 (TA Instruments). First baseline calibrate the DSC instrument and then perform the DSC measurement.

Baseline calibration of DSC instrument. Use software calibration wizard. First obtain a baseline by heating a cell from −80° to 280° C. without any sample in an aluminum DSC pan. Then use sapphire standards as instructed by the calibration wizard. Then analyze 1 to 2 milligrams (mg) of a fresh indium sample by heating the standards sample to 180° C., cooling to 120° C. at a cooling rate of 10° C./minute, then keeping the standards sample isothermally at 120° C. for 1 minute, followed by heating the standards sample from 120° to 180° C. at a heating rate of 10° C./minute. Determine that indium standards sample has heat of fusion=28.71±0.50 Joules per gram (J/g) and onset of melting=156.6°±0.5° C.

Perform DSC measurements on test samples using same DSC instrument. Press test sample of semi-crystalline ethylenic (co) polymer into a thin film at a temperature of 160° C. Weigh 5 to 8 mg of test sample film in DSC pan. Crimp lid on pan to seal pan and ensure closed atmosphere. Place sealed pan in DSC cell, equilibrate cell at 30° C., and heat at a rate of about 100° C./minute to 190° C. Keep sample at 190° C. for 3 minutes, cool sample at a rate of 10° C./minute to −60° C. to obtain a cool curve heat of fusion (Hf), and keep isothermally at −60° C. for 3 minutes. Then reheat sample at a rate of 10° C./minute to 190° C. to obtain a second heating curve heat of fusion (ΔHf). Using the second heating curve, calculate the “total” heat of fusion (J/g) by integrating from −20° C. (in the case of semi-crystalline ethylenic (co) polymers except poly(ethylene-co-alpha-olefin) copolymers of density greater than or equal to 0.90 g/cm³) or −40° C. (in the case of poly(ethylene-co-alpha-olefin) copolymers of density less than 0.90 g/cm³) to end of melting. Using the second heating curve, calculate the “room temperature” heat of fusion (J/g) from 23° C. (room temperature) to end of melting by dropping perpendicular at 23° C. Measure and report “total crystallinity” (computed from “total” heat of fusion) as well as “crystallinity at room temperature” (computed from “room temperature” heat of fusion). Crystallinity is measured and reported as percent (%) or weight percent (wt %) crystallinity from the test sample's second heating curve heat of fusion (ΔHf) and its normalization to the heat of fusion of 100% crystalline polyethylene, where % crystallinity or wt % crystallinity=(ΔHf*100%)/292 J/g, wherein ΔHf is as defined above, * indicates mathematical multiplication, / indicates mathematical division, and 292 J/g is a literature value of heat of fusion (ΔHf) for a 100% crystalline polyethylene.

Moisture Pick-Up Test Method. Measure moisture content of a test sample (Time 0). Then place the test sample in 70% relative humidity at room temperature (23° C.) for 48 hours, and measure moisture content in parts per million (ppm) after 2, 4, 8, 24, and 48 hours by Karl Fisher titration.

### Examples

Comparative carrier resin 1 (CCR1): an ethylene/ethyl acrylate copolymer having a melt flow index 1.3 g/10 min., 85 wt % ethylenic content, 15 wt % ethyl acrylate comonomeric content, a density of 0.93 g/cm³, and a monomodal MWD. By the Crystallinity Test Method parts (A) and (B), (CCR1) had a second heating curve heat of fusion (ΔH_{f}) of 84.2 J/g, and a corresponding crystallinity of 28.8 wt %. Available as product AMPLIFY™ EA 100 Functional Polymer from The Dow Chemical Company.

Constituent (A1) semi-crystalline polyolefin carrier resin 1: a HDPE having a density of 0.965 g/cc³, a melt flow index of 7.5 to 8.5 g/10 min.; and a monomodal MWD. By the Crystallinity Test Method parts (A) and (B), (A1) had a second heating curve heat of fusion (ΔH_{f}) of 223.7 J/g, and a corresponding crystallinity of 76.6 wt %. Available as product AXELERON™ CX 6944 NT CPD from The Dow Chemical Company.

Constituent (B1): zinc oxide obtained as ZOCO-104 from Zochem.

Constituent (B2): organohalogen is 1,2-(pentabromophenyl)ethane, obtained as SAYTEX-8010 from Albermarle Corporation.

Flame retardant synergist compound: antimony trioxide (Sb₂O₃) obtained as BRIGHTSUN HB500 from Albermarle Corporation or HB Chemicals.

Constituent (E1): tetrakismethylene (3,5-di-tert-butyl-4-hydroxyhydrocinnamate) methane (IRGANOX-1010 FF).

Constituent (L1): poly[[6-[(1,1,3,3-tetramethylbutyl)amino]-1,3,5-triazine-2,4-diyl[(2,2,6,6-tetramethyl-4-piperidinyl)imino]-1,6-hexanediyl[(2,2,6,6-tetramethyl-4-piperidinyl)imino]]) obtained as Chimassorb 944 from BASF.

(Hydrolyzable silyl group)-functional polyolefin prepolymer 1 (Host Polymer 1): reactor copolymer of 98.5 wt % ethylene and 1.5 wt % vinyltrimethoxysilane. Prepared by copolymerizing ethylene and vinyltrimethoxysilane in a tubular high pressure polyethylene reactor with a free radical initiator. Available as DFDA-5451 from The Dow Chemical Company.

Comparative Example 1 (CE1): comparative additive masterbatch composition. See composition and moisture pickup test results described in Tables 1 and 2 later.

Inventive Example 1 (1E1): inventive additive masterbatch composition. See composition and moisture pickup test results described in Tables 1 and 2 below.

TABLE 1
Compositions of CE1 and IE1.

| Ex. No. | CE1 | IE1 |
|---|---|---|
| CCR1 | 19.55 | 0 |
| (A1) wt % | 0 | 19.55 |
| (B1) | 0 | 10.00 |
| (B2) | 45.00 | 40.00 |
| FR synergist | 35.00 | 30.00 |
| (E1) wt % | 0.05 | 0.05 |
| (L1) wt % | 0.40 | 0.40 |
| Total wt % | 100.00 | 100.00 |

TABLE 2
Moisture Pick-Up of CE1 and IE1.

| Ex. No. | CE1 | IE1 |
|---|---|---|
| Time 0 | 35.3 | 22.2 |
| 2 hours | 50.9 | 19.9 |
| 4 hours | 81.45 | 24.1 |
| 8 hours | 68.2 | 26.9 |
| 24 hours | 94.6 | 63.6 |
| 48 hours | 107.1 | 45 |

Moisture pick-up data in Table 2 show that the comparative additive masterbatch composition, based on carrier resin that is EEA/HDPE, started with a higher moisture (H₂O) content (Time 0), and had a substantially higher moisture content after 48 hours exposure thereto. In beneficial contrast, the inventive additive masterbatch composition of 1E1, based on semi-crystalline HDPE carrier resin, started with a much lower moisture content and had a much lower moisture content after 48 hours. Thus it can be concluded from the data that the inventive moisture-curable polyolefin composition comprising the inventive additive masterbatch will have lower moisture pickup and thus greater resistance to scorch (premature curing) compared to a comparative moisture-curable polyolefin composition comprising a comparative additive masterbatch composition.

1. An additive masterbatch composition comprising (A) a semi-crystalline polyolefin carrier resin and an additive package comprising (B) a flame retardant; wherein (A) is 10 to 90 weight percent (wt %) and the additive package is from 90 to 10 wt % of total weight (100.00 wt %) of the additive masterbatch composition; wherein the (B) flame retardant comprises (B1) a mineral; and wherein the additive masterbatch composition further comprises a flame retardant synergist compound.

2. The additive masterbatch composition of claim 1 wherein the (A) semi-crystalline polyolefin carrier resin consists essentially of any one of (i) to (viii): (i) a semi-crystalline medium density polyethylene; (ii) a semi-crystalline high density polyethylene; (iii) a semi-crystalline polypropylene; (iv) a semi-crystalline ethylene/propylene copolymer; (v) a semi-crystalline poly(ethylene-co-alpha-olefin) copolymer; (vi) a combination (e.g., mixture or blend) of any two or more of (i), (ii) and (v); (vii) the (A) semi-crystalline polyolefin carrier resin has a crystallinity of 50 to <100 wt %; or (viii) any one of limitations (i) to (vi) and the (A) semi-crystalline polyolefin carrier resin has a crystallinity of 50 to <100 wt %.

3. The additive masterbatch composition of claim 1 wherein the (A) semi-crystalline polyolefin carrier resin has any one of (i) to (x): (i) a density of at least 0.925 g/cm³ and is a polyethylene or a density of 0.89 to 0.90 g/cm³ and is a polypropylene; (ii) a crystallinity of 50 to <100 wt % and is a polyethylene; (iii) a melt flow index (MFI) of 0.1 to 50 grams per 10 minutes (g/10 min.) at 190° C./2.16 kg load and is a polyethylene or a melt flow rate (MFR) of 0.5 to 50 g/10 min. at 230 C./2.16 kg load and is a polypropylene; (iv) a molecular weight distribution (MWD) that is monomodal; (v) a MWD that is bimodal; (vi) both (i) and (ii); (vii) both (i) and (iii); (viii) both (ii) and (iii); (ix) both (iv) and at least one of (i) to (iii); or (x) both (v) and at least one of (i) to (iii).

4. The additive masterbatch composition of claim 1 wherein the (B) flame retardant is a combination of the (B1) mineral and (B2) an organohalogen compound.

5. The additive masterbatch composition of claim 1 further comprising at least one additive selected from: (C) an acidic condensation catalyst; (D) a secondary diarylamine of formula (I): (R¹—Ar)₂NH (I), wherein each Ar is benzene-1,4-diyl or both Ar are bonded to each other and taken together with the NH of formula (I) constitute a carbazol-3,6-diyl; and each R¹ is independently (C₁-C₂₀)hydrocarbyl; (E) one or two second antioxidants, each having a structure different than formula (I) and each other; (F) a processing aid; (G) a colorant; (H) a metal deactivator; (I) an (unsaturated carbon-carbon bond)-free hydrolyzable silane; (J) a corrosion inhibitor; (K) a product of a reaction of (C) and (D); and (L) a hindered amine light stabilizer; and (M) a combination of (K) and any two or more of additives (C) to (J).

6. A moisture-curable polyolefin composition comprising the additive masterbatch composition of claim 1 and a (hydrolyzable silyl group)-functional polyolefin prepolymer; wherein in the (hydrolyzable silyl group)-functional polyolefin prepolymer: (i) each hydrolyzable silyl group is independently a monovalent group of formula (II): (R²)ₘ(R³)₃₋ₘSi— (II); wherein subscript m is an integer of 1, 2, or 3; each R² is independently H, HO—, (C₁-C₆)alkoxy, (C₂-C₆)carboxy, ((C₁-C₆)alkyl)₂N—, (C₁-C₆)alkyl(H)C═NO—, or ((C₁-C₆)alkyl)₂C═NO—; and each R³ is independently (C₁-C₆)alkyl or phenyl; (ii) the polyolefin is polyethylene based, poly(ethylene-co-(C₃-C₄₀)alpha-olefin)-based, or a combination thereof; or (iii) both (i) and (ii).

7. A method of making a moisture-curable polyolefin composition, the method comprising mixing a (hydrolyzable silyl group)-functional polyolefin prepolymer and a divided solid form of the additive masterbatch composition of claim 1 so as to give a mixture; and melting or extruding the mixture so as to make the moisture-curable polyolefin composition.

8. A moisture-cured polyolefin composition that is a product of moisture curing the moisture curable polyolefin composition of claim 6 to give the moisture-cured polyolefin composition.

9. A manufactured article comprising a shaped form of the moisture-cured polyolefin composition of claim 8.

10. A coated conductor comprising a conductive core and a polymeric layer at least partially surrounding the conductive core, wherein at least a portion of the polymeric layer comprises the moisture-cured polyolefin composition of claim 8.

11. A method of conducting electricity, the method comprising applying a voltage across the conductive core of the coated conductor of claim 10 so as to generate a flow of electricity through the conductive core.
